(19) United States
(12) Patent Application Publication
(10) Pub. No.: US 2017/0091806 A1
(43) Pub. Date: Mar. 30, 2017

(54) Attributing an Internet Browsing Session to Television On-air Time

(71) Applicant: Richard Cole, West Chester, PA (US)

(72) Inventor: Richard Cole, West Chester, PA (US)

(21) Appl. No.: 14/865,244

(22) Filed: Sep. 25, 2015

(51) Int. Cl. G06Q 30/02; H04L 29/08

(52) U.S. Cl. CPC G06Q 30/0246; H04L 67/22; G06Q 30/0245

(57) ABSTRACT

In an embodiment, a method includes receiving data indicative of an Internet browsing session of a user. The data includes an identification of a product webpage that the user visited during the Internet browsing session and a first timestamp indicating a time associated with the user's Internet browsing session. The method further includes accessing a show database storing identities of a plurality of products shown on one or more television shows and a plurality of timestamps. The method further includes determining whether the Internet browsing session of the user is attributable to the user viewing one of the television shows by comparing the data indicative of the Internet browsing session of the user with the show database storing identities of the plurality of products shown on the television shows and the plurality of timestamps.

### TECHNICAL FIELD

This disclosure relates generally to Internet browsing attribution, and more particularly to attributing an Internet browsing session to television on-air time.

### BACKGROUND

A user may browse products on an enterprise's website. Some enterprises may also operate television shows. Currently, however, a user's browsing session cannot be attributed to the user watching the television show.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 is a diagram illustrating an example system for attributing an Internet browsing session of a user to a television show, according to certain embodiments of the present disclosure;

FIG. 2 is a diagram illustrating an example data source that may be used in the system of FIG. 1, according to certain embodiments of the present disclosure;

FIG. 3 is a diagram illustrating an example Internet browsing attribution module that may be used in the system of FIG. 1, according to certain embodiments of the present disclosure;

FIG. 4 is a diagram illustrating an example show database that may be stored in the memory of FIG. 3, according to certain embodiments of the present disclosure; and

FIG. 5 is a flow chart illustrating an example method for attributing an Internet browsing session of a user to a television show, according to certain embodiments of the present disclosure.

### DETAILED DESCRIPTION

An enterprise, such as a retailer, may operate a website that allows users to purchase a variety of products. In order to offer enhanced services to its users, the enterprise may want to know the source of each user's Internet browsing session. For example, an enterprise may want to know if a user visited its website via an Internet advertisement. As another example, an enterprise may want to know if a user visited its website through a search engine. As yet another example, an enterprise may want to know if a user visited its website directly through the website's Uniform Resource Locator (“URL”), which may be referred to as a “direct load.” In addition to operating a website, some enterprises may operate one or more other promotional channels, including television shows that offer products to viewers. For example, some enterprises may be both a broadcast and an e-commerce retailer that offers products through various platforms, including broadcast (streaming or over-the-air services), Internet, and mobile platforms. Such enterprises may want to understand whether a user's Internet browsing session is attributable to the user viewing the television show so that the enterprise can more effectively advertise to the user.

Accordingly, aspects of the present disclosure include a method that, in one embodiment, includes receiving, by a computing device, data indicative of an Internet browsing session of a user. The data may include an identification of a product webpage that the user visited during the Internet browsing session and a first timestamp indicating a time associated with the user's Internet browsing session. The method further includes accessing, by the computing device, a show database storing identities of a plurality of products shown on one or more television shows and a plurality of timestamps. Each of the plurality of products may be associated with one or more of the plurality of timestamps. The method further includes determining, by the computing device, whether the Internet browsing session of the user is attributable to the user viewing one of the television shows by comparing the data indicative of the Internet browsing session of the user with the show database storing identities of the plurality of products shown on the television shows and the plurality of timestamps.

The present disclosure may provide numerous advantages. For example, an enterprise may more effectively advertise (e.g., showing certain products at certain times) to a particular user if the enterprise knows the user's viewing and browsing patterns. As another example, attributing a particular user's browsing session to one or more television shows, as opposed to many users' browsing sessions, may allow the enterprise to target advertising to a specific user.

Other technical advantages of the present disclosure will be readily apparent to one skilled in the art from the following figures, descriptions, and claims. Moreover, while specific advantages have been enumerated above, various embodiments may include all, some, or none of the enumerated advantages.

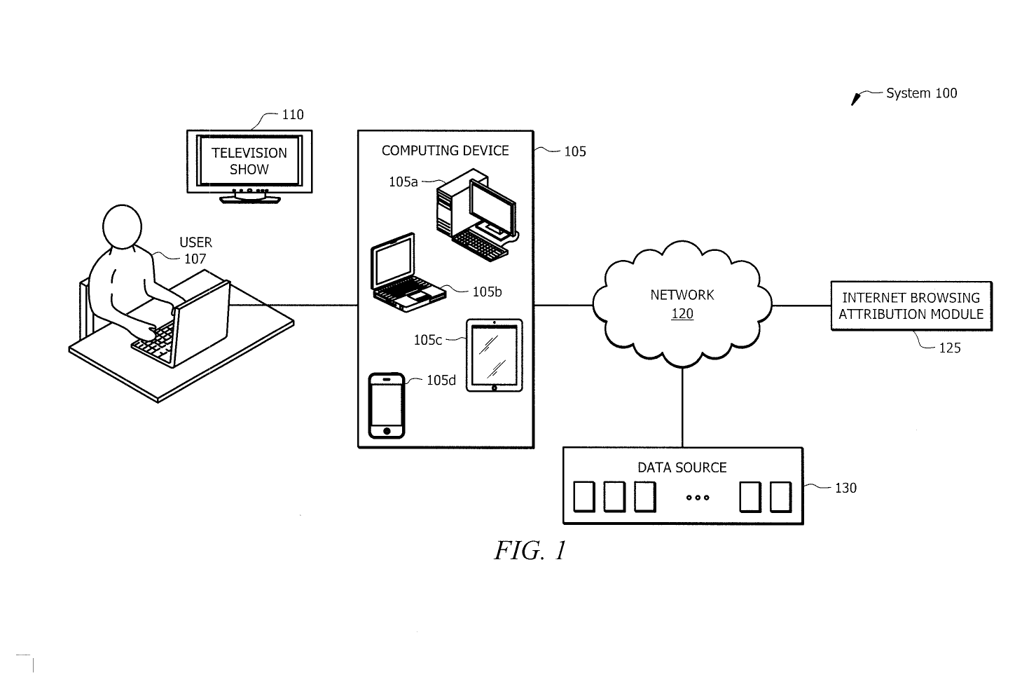

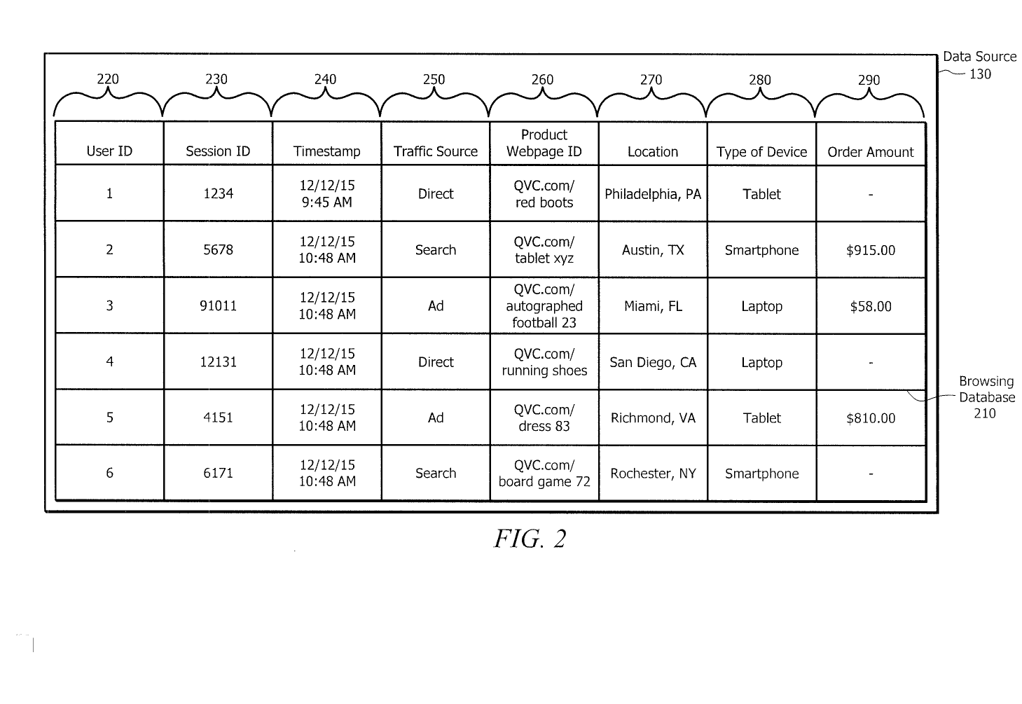

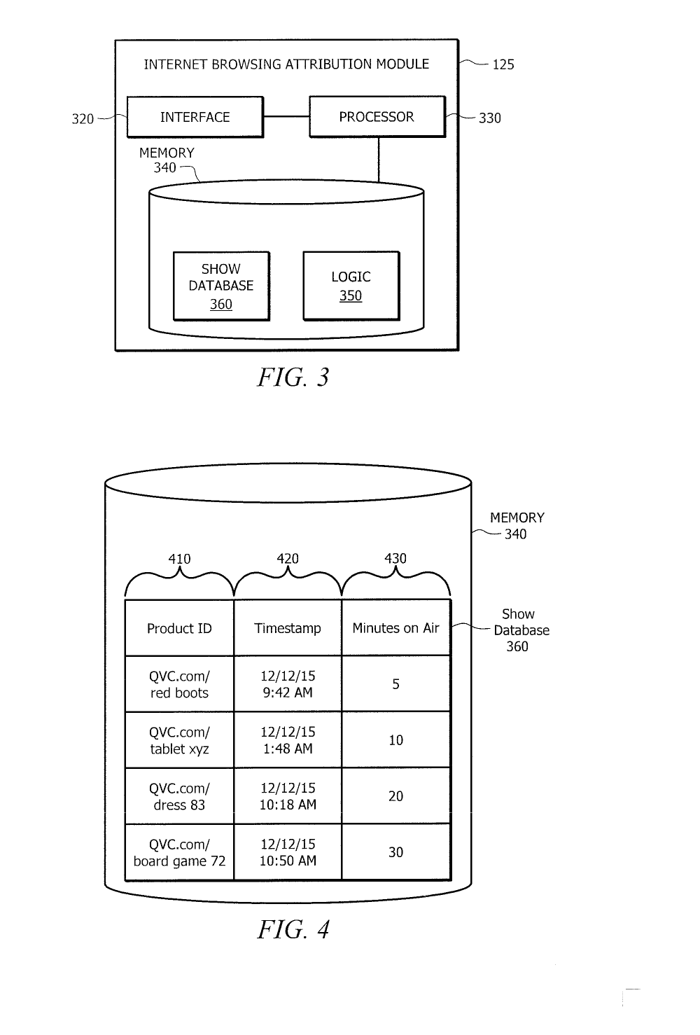

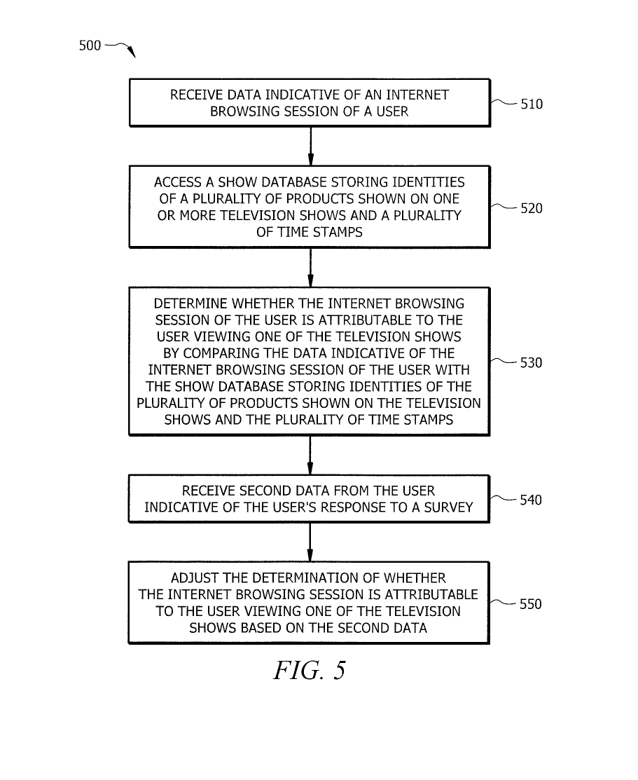

Additional details are discussed with respect to FIGS. 1 through 5. FIG. 1 shows an example system 100 for attributing an Internet browsing session of user 107 to television show 110. FIG. 2 illustrates an example data source 130 that may be used in system 100, while FIG. 3 shows an example Internet browsing attribution module 125 that may be used in system 100. FIG. 4 illustrates an example show database 360 that may be stored in memory 340 of FIG. 3, and FIG. 5 shows an example method 500 for attributing an Internet browsing session of user 107 to television show 110.

FIG. 1 is a diagram illustrating an example system 100 for attributing an Internet browsing session of a user 107 to a television show 110, according to certain embodiments of the present disclosure. System 100 may include a computing device 105, a user 107, a television show 110, a network 120, an Internet browsing attribution module 125, and a data source 130 in certain embodiments.

Computing device 105 may be any type of device suitable to browse the Internet in an embodiment. For example, computing device 105 may include a desktop computer 105a, a laptop computer 105b, a tablet 105c, a smartphone 105d, or any other type of device suitable to browse the Internet. Computing device 105 may allow user 107 to browse an Internet website in an embodiment. For example, computing device 105 may display an Internet website associated with a product offered for sale. Computing device 105 may be connected to Internet browsing attribution module 125 and/or data source 130 through network 120 in certain embodiments. Computing device 105 may send and receive data through network 120 in an embodiment. For example, computing device 105 may send data to data source 130 and/or Internet browsing attribution module 125 through network 120 that is indicative of a response by user 107 to a survey requesting information on whether user 107 watched television show 110. As another example, computing device 105 may send data to data source 130 and/or Internet browsing attribution module 125 that is indicative of an order by user 107 of a product or service. As yet another example, computing device 105 may send data to data source 130 and/or Internet browsing attribution module 125 that is associated with an Internet browsing session of user 107, such as a timestamp indicating a time at which user 107 viewed a website associated with a particular product.

User 107 may be any user of computing device 105. For example, user 107 may be a user of desktop computer 105a, laptop computer 105b, tablet 105c, or smartphone 105d. User 107 may use computing device 105 to browse an Internet website of an enterprise in certain embodiments. For example, user 107 may type the URL of an enterprise's website into computing device 105 to browse the enterprise's website. User 107 may browse particular product webpages of an enterprise's website. For example, user 107 may visit a product webpage associated with an autographed football. As another example, user 107 may visit a product webpage associated with a dress. User 107 may view television show 110 in certain embodiments. For example, user 107 may view a product offered on television show 110. User 107 may then visit a product webpage associated with the product viewed on television show 110 using computing device 105.

Television show 110 may be any television show that offers products in certain embodiments. For example, television show 110 may offer products that user 107 may order through various mediums, such as the Internet or telephone. Television show 110 may be a themed show offering products in some embodiments. For example, television show 110 may include an active wear theme where clothing items associated with fitness are offered for sale. Television show 110 may offer products of any category. For example, television show 110 may offer products related to beauty, electronics, home goods, apparel and accessories, jewelry, or any other product category. Television show 110 may be broadcasted, streamed, or otherwise offered by a content provider. Television show 110 may be shown live or on a taped delay. Television show 110 may be viewed at any time of the day. For example, television show 110 may be shown at 9:00 A.M. As another example, television show 110 may be shown at 10:30 P.M. As discussed below, data associated with each television show 110, such as how many minutes a particular product was shown for each television show 110, may be stored in or accessed using Internet browsing attribution module 125.

Network 120 may be any suitable network operable to facilitate communication between the components of system 100, such as computing device 105, Internet browsing attribution module 125, and data source 130. Network 120 may include any interconnecting system capable of transmitting electrical, audio, video, light, data, messages, signals or any combination of the preceding. Network 120 may include all or a portion of a public switched telephone network (“PSTN”), a public or private data network, a local area network (“LAN”), a metropolitan area network (“MAN”), a wide area network (“WAN”), a local, regional, or global communication or computer network, such as the Internet, a wireline or wireless network, an enterprise intranet, or any other suitable communication link, including combinations thereof, operable to facilitate communication between the components.

Internet browsing attribution module 125 represents any suitable component that facilitates receiving data indicative of an Internet browsing session, accessing show database 360, and determining whether the Internet browsing session of user 107 is attributable to user 107 viewing television show 110, among other functions. Internet browsing attribution module 125 may include a network server, any suitable remote server, a mainframe, a host computer, a workstation, a web server, a personal computer, a file server, or any other suitable computing device operable to communicate with computing device 105, network 120, and data source 130. In some embodiments, Internet browsing attribution module 125 may execute any suitable operating system, such as IBMs, Series/Operating System (Z/OS), MS-DOS, PC, DOS, MAC-OS, Windows, Unix, Open VMS, or any other appropriate operating system including future operating systems. The functions of Internet browsing attribution module 125 may be performed by any suitable combination of one or more servers or other components at one or more locations. In the embodiment where Internet browsing attribution module 125 is a server, the server may be a private server or the server may be a virtual or physical server. The server may include one or more servers at the same or remote locations. Also, Internet browsing attribution module 125 may include any suitable component that functions as a server. In the illustrated embodiment, Internet browsing attribution module 125 may receive data indicative of an Internet browsing session of user 107 from data source 130.

Data source 130 may be any source that includes data indicative of an Internet browsing session of user 107. Data source 130 may include other types of data in an embodiment. For example, data source 130 may include data indicative of a response by user 107 to a survey. Data source 130 may be any collection of structured and/or unstructured data in an embodiment. For example, data source 130 may be a text file, a web page, a database, a spreadsheet, a document, an inventory flat file, a data warehouse, a machine configuration file, or any other suitable source of information. Data source 130 may include data from a source internal or external to an enterprise in an embodiment. Data source 130 may be a single source or a plurality of sources. Data from data source 130 may be communicated to Internet browsing attribution module 125 either directly or over network 120 at any time in an embodiment. For example, data from data source 130 may be communicated to Internet browsing attribution module 125 every day. As another example, data from data source 130 may be communicated to Internet browsing attribution module 125 every month. As another example, data from data source 130 may be communicated to Internet browsing attribution module 125 in real time. Data source 130 may receive data from computing device 105 in some embodiments. A particular embodiment of data source 130 is discussed in reference to FIG. 2 below.

FIG. 2 is a diagram illustrating an example data source 130 that may be used in system 100 of FIG. 1, according to certain embodiments of the present disclosure. Data source 130 may include browsing database 210 in certain embodiments.

Browsing database 210 may be any type of database, spreadsheet, table, or other collection of data that includes data indicative of an Internet browsing session of user 107. Browsing database 210 may include data associated with any number of users of system 100. For example, in addition to data associated with user 107, browsing database 210 may include data associated with multiple other users. Data in browsing database 210 may be provided to Internet browsing attribution module 125 through network 120 in an embodiment. Browsing database 210 may include data associated with multiple Internet browsing sessions of a particular user in an embodiment. Browsing database 210 may include a user identification (“ID”) field 220, a session ID field 230, a timestamp field 240, a traffic source field 250, a product webpage ID field 260, a location field 270, a type-of-device field 280, and an order amount field 290 in certain embodiments.

User ID field 220 may include any type of data that uniquely identifies users, such as user 107. For example, user ID field 220 may include a numerical identifier of user 107, such as a user number. As another example, user ID field 220 may include an alphanumerical identifier of user 107, such as a user name combined with a user number. Data in user ID field 220 may be in any appropriate format.

Session ID field 230 may include any type of data associated with an Internet browsing session of a particular user, such as user 107. For example, session ID field 230 may include a numerical identifier associated with a particular Internet browsing session of a particular user. As another example, session ID field 230 may include an alphanumerical identifier associated with a user's Internet browsing session. Generally, session ID field 230 may include data for a single Internet session of a particular user. For example, if user 107 browses a website and exits the website, session ID field 230 may include a session ID for that particular Internet browsing session. However, if user 107 subsequently returns to the website (e.g., the next day), then session ID field 230 may include a new session ID for the new Internet browsing session of user 107. In some embodiments, session ID field 230 may include data for multiple Internet browsing sessions of a particular user. For example, data in session ID field 230 may include data associated with three Internet browsing sessions of a particular user on a particular day. Data in session ID field 230 may be in any appropriate format.

Timestamp field 240 may include data indicative of a time associated with a user's Internet browsing session. For example, timestamp field 240 may include data indicative of a time at which a user began browsing a particular website, such as when user 107 visited the home page or product webpage of an enterprise's website. As another example, timestamp field 240 may include a duration of a user's browsing session, such as the time user 107 spent on the enterprise's website or the time user 107 spent browsing a particular product webpage of the enterprise's website. Timestamp field 240 may include a single time or multiple times associated with an Internet browsing session. For example, when user 107 visits multiple product webpages of a website, browsing database 210 may include multiple timestamps associated with each visit to each particular product webpage. Data within timestamp field 240 may be in any appropriate format. For example, the data within timestamp field 240 may indicate a date and time associated with an Internet browsing session.

Traffic source field 250 may include data indicative of the source of a user's Internet browsing session in certain embodiments. For example, traffic source field 250 may include data, such as “Direct,” to indicate that a particular user arrived at a website by directly typing in the website's URL. As another example, traffic source field 250 may include data, such as “Search,” to indicate that a particular user arrived at the website through a search performed on a search engine. As yet another example, traffic source field 250 may include data, such as “Ad,” to indicate that a particular user arrived at the website by clicking on an advertisement on the Internet. As yet another example, traffic source field 250 may include data, such as “E-mail,” to indicate that a particular user arrived at the website by clicking on a URL link in an e-mail directing the user to the particular website. Data in traffic source field 250 may be in any appropriate format. For example, the data in traffic source field 250 may include alphabetical data, such as “direct,” “search,” “advertisement,” or any other alphabetical identifier of the source of a user's Internet browsing session. As another example, the data in traffic source field 250 may include alphanumerical data (e.g., “1A” for direct traffic) that corresponds to particular categories of traffic sources.

Product webpage ID field 260 may include data indicative of a product webpage (e.g., a website page associated with a product offered for sale) that a particular user visited during an Internet browsing session in certain embodiments. For example, product webpage ID field 260 may include data indicating that user 107 visited a product webpage for red boots. As another example, product webpage ID field 260 may include data indicating that user 107 visited a product webpage for a tablet xyz. Data in product webpage ID field 260 may be in any appropriate format. For example, the data in product webpage ID field 260 may include a URL of a particular product webpage. As another example, the data in product webpage ID field 260 may include a product number associated with the product offered on the product webpage.

Location field 270 may include data indicative of a location associated with a user's Internet browsing session in an embodiment. For example, location field 270 may include data indicative of a particular city, state, region, country, or continent from which a user's Internet browsing session originated. Data in location field 270 may be in any appropriate format. For example, data in location field 270 may include an alphabetical representation of a city, county, state, country, or continent (e.g., the name of the city). As another example, data in location field 270 may include numerical latitude and longitude coordinates.

Type-of-device field 280 may include data indicative of the computing device 105 used during the Internet browsing session in certain embodiments. For example, data in type-of-device field 280 may indicate that a user used desktop computer 105a. As another example, data in type-of-device field 280 may indicate that a user used tablet 105c. Data within type-of-device field 280 may be in any appropriate format. For example, data in type-of-device field 280 may indicate a category of devices, such as a laptop, smartphone, or desktop computer. As another example, data in type-of-device field 280 may indicate a brand and model number of the device, such as Apple iPhone 6®. As another example, data in type-of-device field 280 may include a unique identifier of computing device 105, such as a serial number or Internet Protocol address.

Order amount field 290 may include data indicative of an amount of money of a user's order in certain embodiments. For example, order amount field 290 may indicate that a user did not spend any money at all. As another example, order amount field 290 may indicate that the user spent $915. Data in order amount field 290 may be in any appropriate format.

Modifications, additions, or omissions may be made to data source 130 without departing from the scope of the disclosure. Although browsing database 210 is illustrated and discussed as including particular fields, browsing database 210 may be modified to include fewer or more fields.

FIG. 3 is a diagram illustrating an example Internet browsing attribution module 125 that may be used in system 100 of FIG. 1, according to certain embodiments of the present disclosure. Generally, Internet browsing attribution module 125 may be used to attribute an Internet browsing session of user 107 to television show 110. For example, Internet browsing attribution module 125 may attribute Internet browsing by user 107 of a product webpage for a baseball bat to user 107 viewing a segment (e.g., ten minutes of on-air time showing the baseball bat) of television show 110. Attributing an Internet browsing session of a particular user, such as user 107, to television show 110 may provide numerous advantages, including the ability to effectively target advertisements to particular users. Internet browsing attribution module 125 may include an interface 320, a processor 330, and a memory 340 in an embodiment. As discussed below, memory 340 may include logic 350 and a show database 360 in an embodiment.

Interface 320 may be any suitable device configured to receive information from network 120, transmit information through network 120, perform processing of information, communicate with other devices, or any combination of the preceding. For example, interface 320 may receive data indicative of an Internet browsing session of user 107 through network 120. As another example, interface 320 may receive data indicative of the identities of products shown on one or more television shows 110 and timestamps corresponding to a time at which a particular product was shown on television show 110. As another example, interface 320 may receive data indicative of a response by user 107 to a survey requesting information on whether user 107 watched television show 110 or information on how long user 107 watched television show 110. In an embodiment, interface 320 represents any port or connection, real or virtual, including any suitable hardware and/or software, including protocol conversion and data processing capabilities, to communicate through a TAN, WAN, MAN, or other communication system that allows Internet browsing attribution module 125 to exchange information with computing device 105 and/or data source 130 through network 120. Interface 320 may be communicatively coupled to processor 330 in certain embodiments.

Processor 330 may control the operation and administration of Internet browsing attribution module 125 by processing information received from interface 320 and memory 340 in an embodiment. Processor 330 communicatively couples with interface 320 and memory 340 in an embodiment. Processor 330 includes any hardware and/or software that operates to control and process information. For example, processor 330 executes logic 350 to control the operation of Internet browsing attribution module 125. Processor 330 may be a programmable logic device, a microcontroller, a microprocessor, any suitable processing device, or any suitable combination of the preceding.

Memory 340 stores, either permanently or temporarily, data, operational software, or other information for processor 330. Memory 340 includes any one or a combination of volatile or non-volatile local or remote devices suitable for storing information. For example, memory 340 may include RAM, ROM, magnetic storage devices, optical storage devices, or any other suitable information storage device or a combination of these devices. Memory 340 may include any suitable information for use in the operation of Internet browsing attribution module 125. In the illustrated embodiment, memory 340 includes logic 350 and show database 360.

Logic 350 generally refers to logic, rules, algorithms, code, tables, and/or other suitable instructions embodied in a computer-readable storage medium for performing the described functions and operations of Internet browsing attribution module 125. For example, logic 350 may receive data indicative of an Internet browsing session of user 107, access show database 360, and determine whether the Internet browsing session of user 107 is attributable to user 107 viewing television show 110 by comparing the data indicative of the Internet browsing session of user 107 with data in show database 360.

Show database 360 may generally include data associated with a plurality of products shown on television show 110 in an embodiment. For example, show database 360 may include data indicative of a product ID of a product shown on television show 110, a time at which the product was shown on television show 110, and how many minutes the product was shown on television show 110. Show database 360 may be any type of database, spreadsheet, table, or other collection of information. Show database 360 may receive data from data source 130 in an embodiment. For example, show database 360 may receive data from data source 130 through network 120 when television show 110 is shown, such as on an hourly, daily, weekly, monthly, or yearly basis. A particular embodiment of show database 360 is discussed in reference to FIG. 4 below.

As an example embodiment of operation, television show 110 may present a tablet on air from 11:45 A.M. to 11:55 A.M. User 107 may view television show 110 and view the tablet during the on-air time. At 12:01 P.M., user 107 may use computing device 105 to visit the product webpage of the tablet shown on television show 110. Interface 320 may subsequently receive data indicative of the Internet browsing session of user 107, including data indicating an identification of the product webpage (e.g., the product webpage for the tablet) that user 107 visited during the Internet browsing session and a timestamp associated with the Internet browsing session (e.g., a timestamp indicating that user 107 visited the product webpage at 12:01 P.M.). Processor 330 may access show database 360, which may store identities of the products shown on television show 110 and timestamps associated with a time at which each product was shown on television show 110. Processor 330 may then determine whether the Internet browsing session of user 107 is attributable to user 107 viewing television show 110 by comparing the data indicative of the Internet browsing session of user 107 with show database 360. Particular examples of determining whether the Internet browsing session of user 107 is attributable to user 107 viewing television show 110 are discussed below in reference to FIG. 5.

FIG. 4 is a diagram illustrating an example show database 360 that may be stored in memory 340 of FIG. 3, according to certain embodiments of the present disclosure. Show database 360 may include a product ID field 410, a timestamp field 420, and a minutes-on-air field 430 in certain embodiments.

Product ID field 410 may include data indicative of an identification of a product shown on television show 110 in an embodiment. Internet browsing attribution module 125 may use data in product ID field 410 to determine if a product shown on television show 110 matches a product that user 107 browsed during an Internet browsing session (e.g., by comparing data stored in product ID field 410 with data in product webpage ID field 260 of browsing database 210). Data in product ID field 410 may be in any appropriate format. For example, data in product ID field 410 may include a URL associated with the product shown on television show 110. As another example, product ID field 410 may include a product number associated with the product shown on television show 110. As yet another example, product ID field 410 may include a product name associated with the product shown on television show 110.

Timestamp field 420 may include data indicative of a particular time at which a product in product ID field 410 was shown on television show 110 in certain embodiments. In some embodiments, Internet browsing attribution module 125 may use data in timestamp field 420 in determining a duration of time between the time at which a product was shown on television show 110 and a time at which user 107 visited the product webpage of the product. Data in timestamp field 420 may be in any appropriate format. For example, data in timestamp field 420 may include a date and time.

Minutes-on-air field 430 may include data indicative of an amount of time a particular product in product ID field 410 was shown on television show 110 in an embodiment. For example, data in minutes-on-air field 430 may indicate that a product was shown for five minutes. As another example, data in minutes-on-air field 430 may indicate that a product was shown for ten minutes. Data in minutes-on-air field 430 may be in any appropriate format. For example, data in minutes-on-air field 430 may be numerical (e.g., 5), alphabetical (e.g., five minutes), or alphanumerical (e.g., 5 minutes).

Modifications, additions, or omissions may be made to show database 360 without departing from the scope of the disclosure. Although show database 360 is illustrated and discussed as including particular fields, show database 360 may be modified to include fewer or more fields.

FIG. 5 is a flow chart illustrating an example method 500 for attributing an Internet browsing session of user 107 to television show 110, according to certain embodiments of the present disclosure. Method 500 begins at step 510 where Internet browsing attribution module 125 may receive data indicative of an Internet browsing session of user 107 in an embodiment. The data may include an identification of a product webpage that user 107 visited during an Internet browsing session. For example, the data received in step 510 may include a URL of a product webpage for a dress that user 107 visited. In some embodiments, the data may include a timestamp indicating a time associated with an Internet browsing session of a particular user. For example, the data may indicate that user 107 visited the URL of the product webpage for the dress at 11:57 A.M. The data may include any of the data in browsing database 210 in certain embodiments. In some embodiments, Internet browsing attribution module 125 may receive data indicative of multiple Internet browsing sessions of a particular user. Internet browsing attribution module 125 may receive the data from data source 130 through network 120 in an embodiment. For example, Internet browsing attribution module 125 may receive the data via 320.

At step 520, Internet browsing attribution module 125 may access show database 360. For example, processor 330 may access memory 340 to open a file or program corresponding to show database 360. As described above, show database 360 may store identities of a plurality of products shown on television show 110. Show database 360 may also store identities of products shown on additional television shows other than television show 110. Show database 360 may include a plurality of timestamps in certain embodiments. Within show database 360, each of the plurality of products may be associated with one or more of the plurality of timestamps in certain embodiments. For example, a particular dress shown on television show 110 at 11:30 A.M. may include a URL for the product webpage for the dress and a timestamp indicating that the dress was shown at 11:30 A.M.

At step 530, Internet browsing attribution module 125 may determine whether the Internet browsing session of user 107 is attributable to user 107 viewing television show 110. In some embodiments, processor 330 may make the determination as described below. In certain embodiments, Internet browsing attribution module 125 may compare data indicative of the Internet browsing session of user 107 with data in show database 360. For example, Internet browsing attribution module 125 may compare a product webpage that user 107 visited with products shown on television show 110. If Internet browsing attribution module 125 determines that there is a match (e.g., product webpage ID field 260 in browsing database 210 and product ID field 410 in show database 360 have matching data for user 107), then Internet browsing attribution module 125 may determine a timestamp indicative of a time at which the product was shown on television show 110 in an embodiment. For example, Internet browsing attribution module 125 may look up data in timestamp field 420 associated with the particular product. Internet browsing attribution module 125 may then compare a time at which user 107 visited the website to the time at which the product was shown on television show 110 in an embodiment. In some embodiments, Internet browsing attribution module 125 may determine a time difference between a time at which user 107 visited the website to a time at which the product was shown on television show 110 and compare the time difference to a predetermined amount of time. If Internet browsing attribution module 125 determines that the time difference does not exceed the predetermined amount of time, then Internet browsing attribution module 125 may attribute the Internet browsing session to user 107 viewing television show 110. In embodiments where Internet browsing attribution module 125 receives data indicative of multiple Internet browsing sessions of a particular user, Internet browsing attribution module 125 may perform the above operations for each Internet browsing session of the particular user. For example, Internet browsing attribution module 125 may compare data indicative of each Internet browsing session of user 107, such as each webpage ID field 260 for each Internet browsing session of user 107, with data in show database 360.

As an example of step 530, Internet browsing attribution module 125 may determine that a user having a User ID of 1 visited the product webpage for red boots. Internet browsing attribution module 125 may search show database 360 to determine that red boots were shown on television show 110. Internet browsing attribution module 125 may compare product webpage ID field 260 with product webpage ID field 410 to determine that both fields contain matching data (QVC.com/red boots). Internet browsing attribution module 125 may access timestamp field 240 of browsing database 210 to determine that the user visited the product webpage for red boots at 9:45 A.M. on Dec. 12, 2015. Internet browsing attribution module 125 may access timestamp field 420 of show database 360 to determine that the red boots were shown on television show 110 at 9:42 A.M. on Dec. 12, 2015. Internet browsing attribution module 125 may determine that the user visited the product webpage for the red boots three minutes after the red boots were shown on television show 110. Internet browsing attribution module 125 may compare the three-minute time difference to a predetermined threshold, such as one hour. Since the three-minute time difference is less than the one-hour threshold, Internet browsing attribution module 125 may attribute the Internet browsing session of the user to the user viewing television show 110.

As another example of step 530, Internet browsing attribution module 125 may determine that a user having a User ID of 2 visited the product webpage for tablet xyz. Internet browsing attribution module 125 may search show database 360 to determine that tablet xyz was shown on television show 110. Internet browsing attribution module 125 may compare product webpage ID field 260 with product webpage ID field 410 to determine that both fields contain matching data (QVC.com/tablet xyz). Internet browsing attribution module 125 may access timestamp field 240 of browsing database 210 to determine that the user visited the product webpage for tablet xyz at 10:48 A.M. on Dec. 12, 2015. Internet browsing attribution module 125 may access timestamp field 420 of show database 360 to determine that tablet xyz was shown on television show 110 at 1:48 A.M. on Dec. 12, 2015. Internet browsing attribution module 125 may determine that the user visited the product webpage for tablet xyz nine hours after tablet xyz was shown on television show 110. Internet browsing attribution module 125 may compare the nine-hour time difference to a predetermined threshold, such as one hour. Since the nine-hour time difference is greater than the one-hour threshold, Internet browsing attribution module 125 may not attribute the Internet browsing session of the user to the user viewing television show 110.

At step 540, Internet browsing attribution module 125 may receive data from user 107 indicative of a response by user 107 to a survey in an embodiment. For example, the data received in step 540 may indicate whether user 107 watched television show 110. As another example, the data may indicate a length of time user 107 watched television show 110. Internet browsing attribution module 125 may receive the data directly from user 107 through network 120 in some embodiments. Internet browsing attribution module 125 may receive the data indirectly from user 107 in other embodiments. For example, data indicative of a response by user 107 to the survey may be provided to data source 130, and Internet browsing attribution module 125 may receive the data from data source 130 through network 120. Internet browsing attribution module 125 may receive the data via interface 320 in an embodiment.

At step 550, Internet browsing attribution module 125 may adjust the determination of whether the Internet browsing session is attributable to user 107 viewing one of television shows 110 based on the data received in step 540 in an embodiment. For example, if Internet browsing attribution module 125 initially determines that an Internet browsing session of user 107 is attributable to user 107 viewing television show 110, but user 107 indicates that he or she did not view television show 110, then Internet browsing attribution module 125 may adjust the initial determination to indicate that the Internet browsing session is not attributable to television show 110. As another example, if Internet browsing attribution module 125 initially determines that an Internet browsing session of user 107 is not attributable to user 107 viewing television show 110, but Internet browsing attribution module 125 receives data indicating that user 107 did view television show 110, then the initial determination may be adjusted to indicate that the Internet browsing session is attributable to viewing television show 110. In some embodiments, processor 330 may adjust the determination as described above.

As an example embodiment of operation, user 107 may view a pair of running shoes on television show 110 at 11:30 A.M. User 107 may then use computing device 105 to browse a product webpage associated with the running shoes at 11:45 A.M. Internet browsing attribution module 125 may receive data indicative of the Internet browsing session of user 107. The data may include an identification of a product webpage associated with the running shoes that user 107 visited during the Internet browsing session and a timestamp indicating that user 107 visited the product webpage (or user 107 began the browsing session) at 11:45 A.M. Internet browsing attribution module 125 may access show database 360, which may store identities of a plurality of products shown on television show 110, such as the running shoes viewed by user 107. Each product, including the running shoes, in show database 360 may be associated with a timestamp indicating a time at which the product was shown on television show 110. In this particular example, show database 360 may indicate that the running shoes were shown at 11:30 A.M. Internet browsing attribution module 125 may then determine whether the Internet browsing session of user 107 (e.g., the visit by user 107 to the product webpage for the running shoes) is attributable to user 107 viewing the running shoes on television show 110. Internet browsing attribution module 125 may make the determination by comparing the data indicative of the Internet browsing session (e.g., the product webpage for the running shoes and the time at which user 107 visited the product webpage) with data in show database 360 (e.g., the running shoes shown on television show 110 and the time at which the running shoes were shown). Internet browsing attribution module 125 may additionally receive data from user 107 indicating whether user 107 viewed the running shoes on television show 110. Based on the received data, Internet browsing module 125 may adjust the determination of whether the Internet browsing session is attributable to user 107 viewing the running shoes on television show 110.

The attribution method of the present disclosure may provide numerous advantages. For example, an enterprise may more effectively advertise (e.g., showing certain products at certain times) to user 107 if the enterprise knows the viewing and browsing patterns of user 107. As another example, attributing a browsing session of a particular user, as opposed to multiple users' browsing sessions, allows the enterprise to target advertising to the particular user, such as user 107.

Although the present disclosure has been described with several embodiments, a myriad of changes, variations, alterations, transformations, and modifications may be suggested to one skilled in the art. The present disclosure encompasses such changes, variations, alterations, transformations, and modifications.

What is claimed is:

1. A system, comprising:
a network interface operable to receive data indicative of an Internet browsing session of a user, the data comprising an identification of a product webpage that the user visited during the Internet browsing session and a first timestamp indicating a time associated with the user's Internet browsing session; and
a processor communicatively coupled to the network interface, the processor operable to:
access a show database storing identities of a plurality of products shown on one or more television shows and a plurality of timestamps, each of the plurality of products associated with one or more of the plurality of timestamps; and
determine whether the Internet browsing session of the user is attributable to the user viewing one of the television shows by comparing the data indicative of the Internet browsing session of the user with the show database storing identities of the plurality of products shown on the television shows and the plurality of timestamps.

2. The system of claim 1, wherein the network interface is further operable to receive second data indicative of the user's response to a survey requesting information on whether the user watched one of the television shows.

3. The system of claim 1, wherein the network interface is further operable to receive second data indicative of the user's response to a survey requesting information on a length of time the user watched one of the television shows.

4. The system of claim 3, wherein the processor is further operable to adjust the determination of whether the Internet browsing session is attributable to the user viewing one of the television shows based on the second data.

5. The system of claim 1, wherein the first timestamp comprises a time at which the user viewed a particular product webpage.

6. The system of claim 1, wherein comparing the data indicative of the Internet browsing session of the user with the show database storing identities of the plurality of products shown on the television shows and the plurality of timestamps comprises:
matching a product corresponding to the product webpage visited during the browsing session with a product in the show database;
determining a second timestamp associated with the matched product in the show database, wherein the second timestamp is indicative of a time at which the product was shown on one of the television shows;
determining a time difference between the first timestamp and the second timestamp; and
comparing the time difference to a predetermined amount of time.

7. The system of claim 6, wherein the processor is further operable to:
determine that the time difference does not exceed the predetermined amount of time; and
attribute the user's Internet browsing session to the user viewing one of the television shows based on the determination that the time difference does not exceed the predetermined amount of time.

8. The system of claim 1, wherein the product webpage was visited by the user on a computing device selected from:
a desktop computer;
a laptop computer;
a smartphone; and
a tablet.

9. A method, comprising:
receiving, by a computing device, data indicative of an Internet browsing session of a user, the data comprising an identification of a product webpage that the user visited during the Internet browsing session and a first timestamp indicating a time associated with the user's Internet browsing session;
accessing, by the computing device, a show database storing identities of a plurality of products shown on one or more television shows and a plurality of timestamps, each of the plurality of products associated with one or more of the plurality of timestamps; and
determining, by the computing device, whether the Internet browsing session of the user is attributable to the user viewing one of the television shows by comparing the data indicative of the Internet browsing session of the user with the show database storing identities of the plurality of products shown on the television shows and the plurality of timestamps.

10. The method of claim 9, further comprising:
receiving, by the computing device, second data indicative of the user's response to a survey requesting information on whether the user watched one of the television shows.

11. The method of claim 9, further comprising:
receiving, by the computing device, second data indicative of the user's response to a survey requesting information on a length of time the user watched one of the television shows.

12. The method of claim 11, further comprising adjusting, by the computing device, the determination of whether the Internet browsing session is attributable to the user viewing one of the television shows based on the second data.

13. The method of claim 9, wherein the first timestamp comprises a time at which the user viewed a particular product webpage.

14. The method of claim 9, wherein comparing the data indicative of the Internet browsing session of the user with the show database storing identities of the plurality of products shown on the television shows and the plurality of timestamps comprises:
matching, by the computing device, a product corresponding to the product webpage visited during the browsing session with a product in the show database;
determining, by the computing device, a second timestamp associated with the matched product in the show database, wherein the second timestamp is indicative of a time at which the product was shown on one of the television shows;
determining, by the computing device, a time difference between the first timestamp and the second timestamp; and
comparing, by the computing device, the time difference to a predetermined amount of time.

15. The method of claim 14, further comprising:
determining, by the computing device, that the time difference does not exceed the predetermined amount of time; and
attributing, by the computing device, the user's Internet browsing session to the user viewing one of the television shows based on the determination that the time difference does not exceed the predetermined amount of time.

16. The method of claim 9, wherein the product webpage was visited by the user on a computing device selected from:
a desktop computer;
a laptop computer;
a smartphone; and
a tablet.

17. A system, comprising:
means for receiving data indicative of an Internet browsing session of a user, the data comprising an identification of a product webpage that the user visited during the Internet browsing session and a first timestamp indicating a time associated with the user's Internet browsing session;
means for accessing a show database storing identities of a plurality of products shown on one or more television shows and a plurality of timestamps, each of the plurality of products associated with one or more of the plurality of timestamps; and
means for determining whether the Internet browsing session of the user is attributable to the user viewing one of the television shows by comparing the data indicative of the Internet browsing session of the user with the show database storing identities of the plurality of products shown on the television shows and the plurality of timestamps.

18. The system of claim 17, further comprising means for receiving second data indicative of the user's response to a survey requesting information on a length of time the user watched one of the television shows.

19. The system of claim 18, further comprising means for adjusting the determination of whether the Internet browsing session is attributable to the user viewing one of the television shows based on the second data.

20. The system of claim 17, wherein the first timestamp comprises a time at which the user viewed a particular product webpage.

21. The system of claim 17, wherein the means for comparing the data indicative of the Internet browsing session of the user with the table comprising the plurality of products shown on the television show and the plurality of timestamps comprises:
means for matching a product corresponding to the product webpage visited during the browsing session with a product in the show database;
means for determining a second timestamp associated with the matched product in the show database, wherein the second timestamp is indicative of a time at which the product was shown on one of the television shows;
means for determining a time difference between the first timestamp and the second timestamp; and
means for comparing the time difference to a predetermined amount of time.

22. The system of claim 21, further comprising:
means for determining that the time difference does not exceed the predetermined amount of time; and
means for attributing the user's Internet browsing session to the user viewing one of the television shows based on the determination that the time difference does not exceed the predetermined amount of time.

23. The system of claim 17, wherein the product webpage was visited by the user on a computing device selected from:
a desktop computer;
a laptop computer;
a smartphone; and
a tablet.
